(19) United States
(12) Patent Application Publication
(10) Pub. No.: US 2007/0168958 A1
(43) Pub. Date: Jul. 19, 2007

(54) Method and apparatus for cross organizational sharing of software applications using host platform

(75) Inventors: Jin Huang, Mountain House, CA (US); Sungli Yang, San Ramon, CA (US); Anita Narra, Pleasanton, CA (US); Lawrence Lindsey, Livermore, CA (US); Paul M. Tabet, Danville, CA (US)

Correspondence Address: MORRISON & FOERSTER LLP, 755 PAGE MILL RD, PALO ALTO, CA, 94304-1018, US

(73) Assignee: Nsite Software, Inc., Pleasanton, CA (US)

(21) Appl. No.: 11/286,306

(22) Filed: Nov. 23, 2005

(51) Int. Cl. G06F 9/44

(52) U.S. Cl. 717/120

(57) ABSTRACT

Method and apparatus for a system for sharing a business process in the form of a software application (computer program) between at least two organizations. The shared software application is typically in the form of one or more web pages having associated data and logic and accessed by a conventional web browser and transmitted over the Internet between the two organizations. The two organizations need not have a shared computer system or even a common computer operating system. The business process underlying the software application may be for instance a vendor/supplier relationship but can be other more complex relationships such as third party sales representatives, business consulting, or computer support. The system includes the ability to configure the business process in terms of the software application which would include business logic and draw on data in the form of a database maintained by one of the organizations. The system uses a host server which supports both the software application and the sharing process.

### FIELD OF THE INVENTION

This invention relates generally to computer software and to specifically organizations sharing software.

### BACKGROUND

Typically an organization, which may be for instance a business enterprise or other type of organization including a part of a company or other commercial entity or a nonprofit or governmental organization or part of such an organization, maintains its own computer system. There is a tendency for transactions (business processes) between such organizations to be carried out by computer enabled methods, for instance using the Internet. This has been done to a limited extent using computer software that supports purchasing of goods and services by one company from another such as EDI (electronic data interchange). Typically some sort of shared transactional software is involved so that even if the two companies have different computer systems operating for instance with different operating systems and applications (programs) one company can place orders with the other using a shared piece of software, also referred to as a software application or program. Heretofore such software sharing has been relatively limited since each organization typically maintains its own computer system, software, and software standards and such sharing is technically difficult or impossible.

These cross organizational transactions typically involve not just transmitting data but also some sort of sharing of the computer code which supports the business process, for instance the purchase of goods or services. However such sharing has been limited to, for instance, the vendor/supplier relationship using the EDI process.

### SUMMARY

The present inventors have identified the need for greater sharing of software applications and data, not limited to the purchase of goods and services between organizations. As stated above, an organization here is not necessarily merely a commercial entity but may be for instance a part of a commercial entity or a part of a governmental or nonprofit organization. Even within one entity, for instance a government agency, there may be disparate computer systems and in the present situation it is not possible to share software applications even inside one such entity. The same situation obtains with large commercial entities such as companies which may have different computer systems and different software standards and operating systems for instance at different locations or divisions. Hence the “organization” here is not necessarily a single commercial or other entity but a group of people (users) with a shared computer system not fully available to outsiders.

The present inventors have determined that it is desirable to be able to share software applications in terms of both the business logic and data between such organizations in spite of differing computer systems. In the prior art there is the known electronic data interchange which uses private networks for data exchange only. However the present system and method are not so limited and generally are compatible with all business processes which are computer enabled.

In the present system the shared business processes are in one embodiment centrally hosted software objects, such as software applications, resident on a host server or platform. Server and platform here generally refer to software entities rather than to a physical computer (machine). Here in certain embodiments the server is a software services platform. This server which supports the software sharing is not necessarily under the control of either organization but instead may be under control of a third (software service) organization. The present system in some embodiments uses standard applications or templates upon which the organization(s) may build a shared software application. Moreover the present software applications are web applications, that is operable over the Internet, to enable the enterprise-to-enterprise or cross-organization sharing of such applications between different organizations/enterprises. This also allows a multi-tenant architecture in terms of the server database. For instance, one enterprise can draw on software objects (e.g., applications or components of applications) maintained by several different other organizations. This allows the use of web applications such as described in co-pending U.S. patent application Ser. No. 11/241,073, commonly owned, filed Sep. 30, 2005 entitled “Browser Based Designer and Player” inventors Pawan Nachnani et al, incorporated herein by reference in its entirety, where the logic or business rules are part of the software application.

Hence the present system supports relationships between organizations such as for purchases and other business purposes. It may use software applications built using a web applications builder (designer) of the type disclosed in the above-described patent application.

In accordance with the present system the first organization transmits an invitation to the second organization (the recipient) and includes with the invitation a reference to the hosted software application or other object. The invitation is typically transmitted over the Internet. The entire sharing transaction is managed and accessed at either organization using a standard web browser such as Internet Explorer. An individual is the target of the invitation at the recipient organization. This need not be a particular named individual but, for instance, a person holding a particular job or function. The receiving organization transmits its acceptance back. One or the other organization configures the business process, for instance using a template or otherwise, to arrive at a shared software application. Access to the shared software application is then routed to recipients at both organizations for approval and/or editing before it is put into effect (activated). Thus there is both an activation and modification of the software application before it is actually released for use by either organization. Included is a queuing feature to determine an ordered list of recipients at each organization and a routing management function to make sure that the software application before being approved is routed to the correct individuals. Typically each software application includes at least one web page including business logic and for data draws on a database maintained by one or the other organizations or at the host.

The server, which may be a hosted server (platform) maintained by yet a third organization, includes in one embodiment a multi-tenant database for supporting with the data such sharing of software applications by various parties. There is also included in the server a routing engine for the routing logic (rules) and a process control module for the actual routing.

Examples of business processes suitable for such sharing are purchases and sales, third party sales activities, joint consulting projects, third party computer support, and third party computer software development. In accordance with this system both the inviting and the recipient organization have tracking and reporting capability of the current status of the shared software application.

Hence the present business process sharing includes first a connection phase including the invitation to share the business process and an acceptance transmitted back. A configuration phase follows in which the associated software application is assigned to relevant users by one or the other organization. Overlying these is a routing phase which involves queues (ordered lists) of recipients at either organization for approvals and subsequent use.

In one case, the two organizations have an existing business relationship and they want to develop a suitable software application to share between them for carrying out some associated business process. However this is not required in other embodiments where the invitation may be directed to a party with whom the transmitting party (inviter) does not have an existing relationship. Hence there may be some prior “matchmaking” or advertising aspect. Typically the invitation includes a reference to a version of the shared software application as defined by the inviting organization. As mentioned above, this is typically in a form of one or more hosted web pages which include business logic and draw on data supplied by the inviting organization.

The system supports the aspects of supporting the initial invitation, sharing other software applications, unsharing previously shared software applications, changing routing settings, changing which routing list is to be used, canceling the relationship and reassigning initiators for particular business processes, where the initiator is an individual at the inviting organization. It is also possible that after a shared software application has been developed, for one or the other organization to share this with yet a third organization. Typically this would be done by the original inviting organization.

In one embodiment all the relevant software (except for the conventional web browser) is resident on the host platform (e.g. server) rather than being resident at the computers of the users at either organization. Various aspects of the system are made available to the inviter and invited organizations, as desired. For example to use the shared process the second (invited) organization need not be able to issue an invitation itself, and so may have reduced functionality.

### BRIEF DESCRIPTION OF THE FIGURES

FIG. 1 is a component diagram for the present system.

FIG. 2A is a block diagram of the present system showing classes of participants.

FIG. 2B is an illustrative entity relationship diagram corresponding to the class diagram of FIG. 2A.

FIG. 3 is a depiction of partner management.

FIG. 4 is a routing flow chart.

FIG. 5 is a routing registration sequence diagram.

FIG. 6 is a first partner invitation screen.

FIG. 7 is a second partner invitation screen.

FIGS. 8A and 8B are new selection/sorting registration screens.

FIG. 9 shows in a block diagram structure of the present system and its logic flow.

FIG. 10 shows in a diagram a typical use for the invitation.

FIG. 11 is a class diagram for the invitation.

FIG. 12 is a sequence diagram.

FIG. 13 is a diagram of the acceptance of the invitation.

FIG. 14 is a class diagram associated with FIG. 13.

FIG. 15 is a sequence diagram.

FIG. 16 is a diagram for the invitation software application.

FIG. 17 is a screen of the partner invitation for the administrator.

FIG. 18 is a select initiator screen.

FIG. 19 is a partner management screen.

FIG. 20 is a first screen in a transaction.

FIG. 21 is a further screen of the transaction.

FIG. 22 is a further screen of the transaction.

FIG. 23 is a further screen of the transaction.

FIG. 24 is a further screen of the transaction.

FIG. 25 is a further screen of the transaction.

### DETAILED DESCRIPTION

The following description is presented to enable one skilled in the art to make and use the present invention, and is provided in the context of particular uses and their requirements. Various modifications to preferred embodiments will be readily apparent to those skilled in the art, and the generic principles defined herein and may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

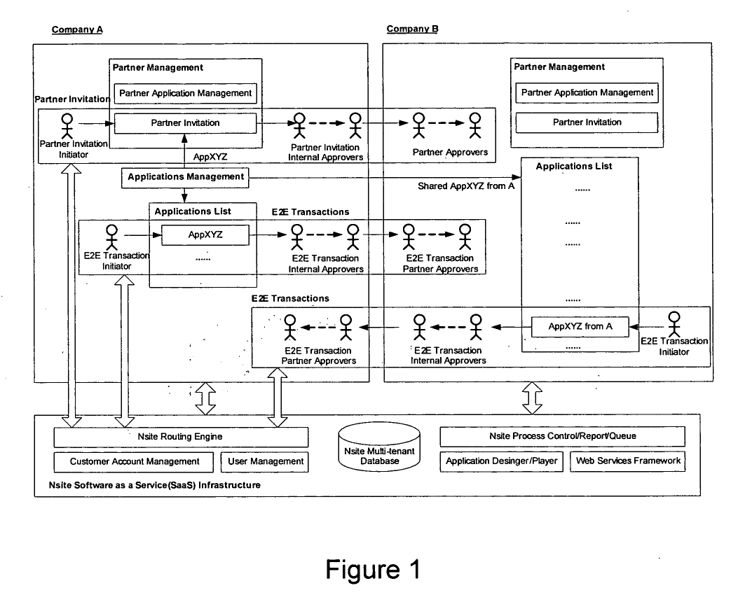

FIG. 1 is a component diagram for the present system. The present system allows organizations to share business processes in the form of software applications. One organization allows another to use one of their software applications for processes, which involve both organizations. These cooperating partners thereby create a closed loop process with monitoring and tracking abilities. The various users, that is human beings, involved with each partner are able to access the shared business processes with a single sign-on to an account with a third party host, in one embodiment. Use of the third party host is not required but is illustrative.

FIG. 1 shows (upper portion) two organizations Companies A and B sharing a software application (App) as described above. Each company uses Partner Management functionality as described herein to manage the sharing of the application via the Partner Application Management finction. The invitation initiator who sends the partner invitation is shown at Company A and the approvers are at both Company A and B. Company A has the Applications Management software that interacts with the Applications List at Company B, which list includes the shared application App. This software application App supports the underlying transactions (business process) between Companies A and B, with the associated approvers at both Companies A and B and the transaction initiator at Company B. Underlying this (lower portion of figure) is the, e.g., hosted server or platform (which here is software, not necessarily a machine) including for operation of the present system the routing engine (logic), multi-tenant database for the pertinent data being used by the application, and the functionality of process control, reporting, and queuing all for routing. Also included in the platform are software modules for customer account management and user management for routing purposes, as well as the application designer/player and web services framework, see respectively, the above cited U.S. patent application and commonly owned U.S. patent application Ser. No. ______, filed Nov. 23, 2005, Jin Huang et al. “Designer and Player for Web Services Applications,” incorporated herein by reference in its entirety.

To initiate a shared partner software application, an individual (user) who is the initiator is assigned by an administrator of the invited organization. After the user is assigned as an initiator, that user will see the software application displayed in a list under the heading of the partner (the other organization) name on his computer in a web browser screen. It is understood that each user has or has access to a conventional desktop/laptop/other computer equipped in terms of software with at least a web browser and Internet and e-mail access, all conventional. Initiating a shared software application follows a routine. First, there is provided a routing registration screen (web page), which has a company (organization) name column for shared business processes. (“Screen” here refers to what is seen on the computer display.) Initiators can select multiple internal registered users where “user” here refers to a human being rather than a computer or software entity. Initiators cannot select any outside contacts as an initiator in one embodiment. Of course, this is not limiting in other embodiments. Initiators in one embodiment can only select one recipient from the partner organization. At least one recipient (user) is required from the partner organization. The routing registration screen, e.g. web page, presented to the user by the present system has an organization name column for shared business processes. The individual who is the recipient for the partner organization is an approver. When a participant from the initiating company views on his computer the status of the routing, he will see on the screen only the name of the first participant and the organization name of the partner organization. For example, if the first participant adds ten participants the participant past due after column and routing past due after columns will change accordingly. (These user screens are further illustrated below.) From the time the first participant views the software application, the routing is displayed as viewed. If the first participant has added, for instance, ten other participants, the status for the first participant will be shown on the screen as viewed until all ten participants have accepted the proposed software application or one of the ten rejects or stops the acceptance process.

Similar to the routing screen provided to users at the initiating organization, the receiving (invited) users at the receiving organization only see the name of one participant. The recipients for the receiving organization see only the name of the initiator. The initiator status is shown for all participants while the routing is being handled at the initiator. First recipients at the receiving organization (inviter organization) of a shared business process are treated similar to second initiators in that they can add participants and set priority and timeframes for the recipients internal to their organization. Any changes will be displayed in an “in progress” list on the relevant screen and status displays for the routing phase.

Once a business process (e.g., a software application) has been shared from a first organization to a second organization, the first organization can route the business process to the second organization, and vice versa. If the first organization invites the second organization with an application named APP, then a user in the second organization can start to initiate APP, and APP will eventually be routed to the first organization. In the same partnership setting, where the first organization invites the second organization, a user in the first organization can route APP to the second organization.

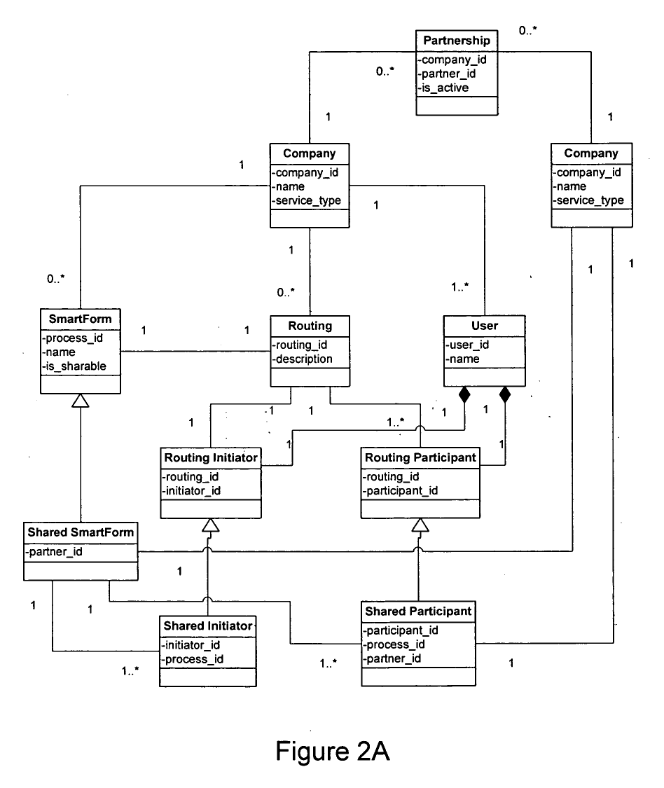

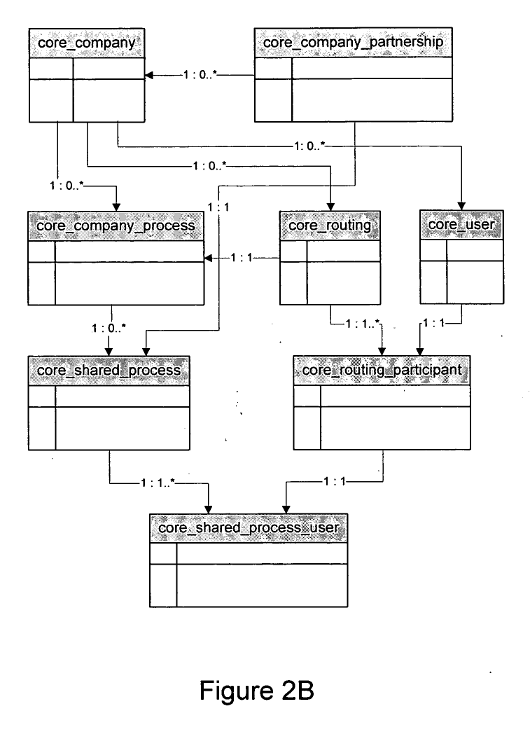

FIG. 2A shows a class diagram for this aspect. “Company” here refers to an organization. For each block there is shown class name (top of block) and the objects (attributes) addressed thereby. For instance for the top most entity which is the partnership itself there is provided an identification of each company (organization), the identification of the partner (which is the other organization) and an indication of whether the partnership is currently active or not. The numbers conventionally indicate the number of occurrences for each class for the associated class.

FIG. 2B is an illustrative entity relationship diagram corresponding to the class diagram of FIG. 2A.

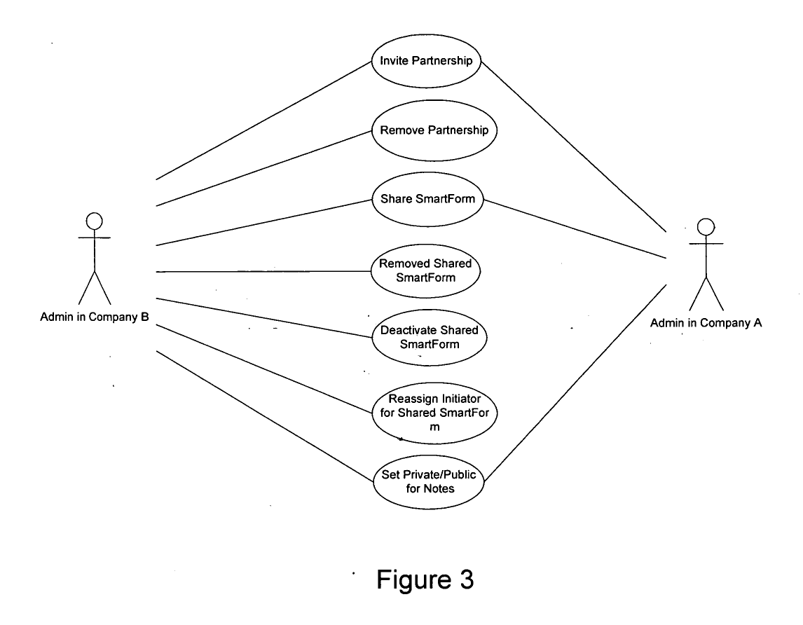

FIG. 3 shows in a sketch how the partner management, which is the relationship between the two organizations for purposes of showing a business process, operates. In this case, there is an administrator in each of company A and B where the two companies (organizations) are the entities forming the partnership. The administrator is a user designated for purposes of process management. The activities as shown involve inviting a partnership, removing the partnership, sharing a smart form (software application), removing the shared software application, deactivating a shared software application, reassigning an initiator for a shared software application, and setting private/public designation for notes (annotations to the software application).

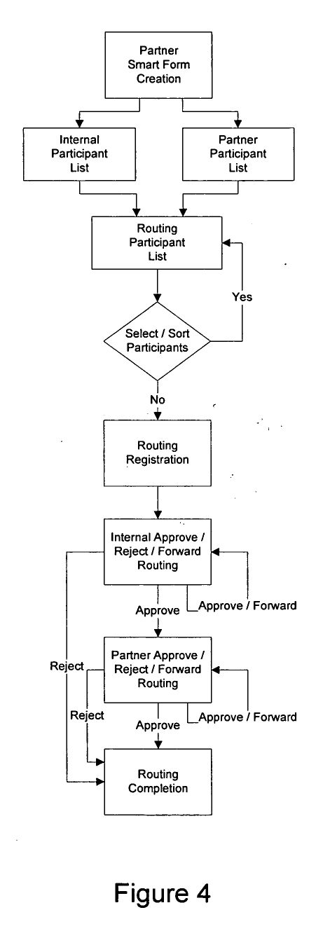

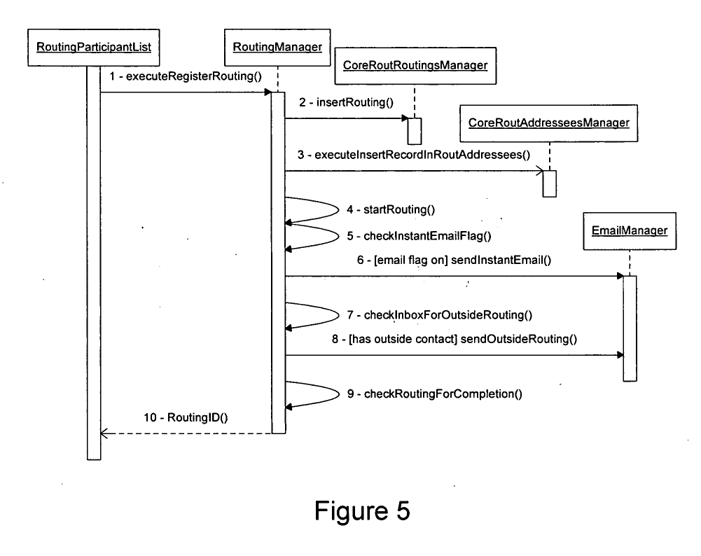

A significant aspect of this sharing of business applications is routing of the business applications inside each organization for proper approvals. Hence FIG. 4 shows a routing flow chart to make sure that proper approvals are obtained for each business process prior to its activation. This is self explanatory; as shown any individual can approve or forward or reject a particular software application. Also relevant is FIG. 5 showing how the routing registration takes place in terms of a sequence. The chief software entities are shown are the routing participant list, the routing manager, the core routing manager, the core route address manager and the email manager. All communications here are handled by email. As shown, steps 1-9 handle these particular functions.

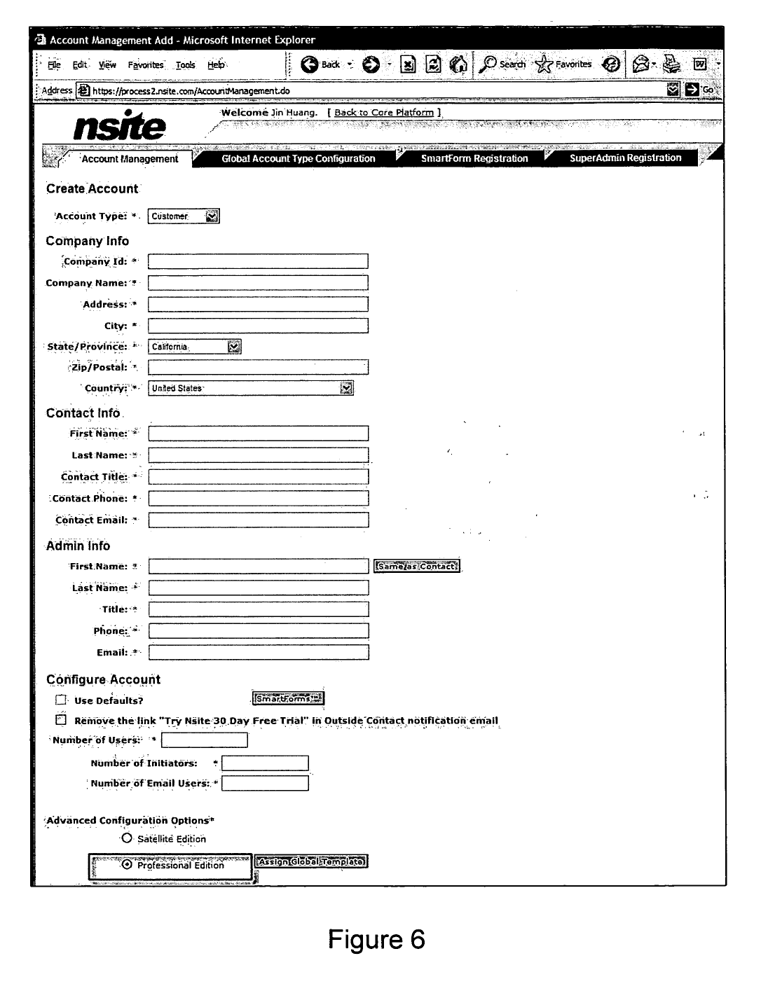

FIG. 6 is an illustrative drawing of an account management screen. A system administrator, e.g., an administrator acting on behalf of a hosting organization, configures and maintains the account information for each organization. The inviting organization has to be an account of type “Professional Edition” and the invited organization does not have to be an account of type “Professional Edition”. In other words, the organizations with a Satellite Edition will not be able to invite partners or see the “Applications Shared” portion of the relationship management screen.

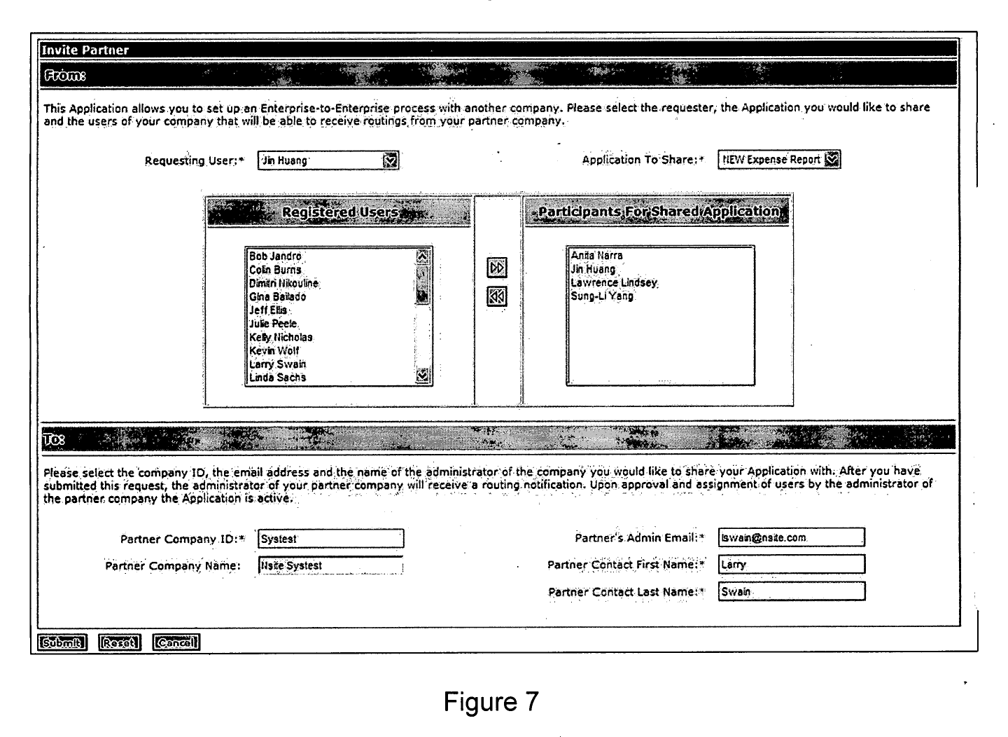

FIG. 7 is an illustrative drawing of a partner invitation screen. The data fields are filled in or clicked on by the user as needed.

The required information for the invitation (FIG. 7) is in one embodiment first a requesting user name/e-mail address, which is a user from the requesting organization, next a designation of the particular software application to be shared, in other words the software application which the requesting organization wants the other company to initiate, and the recipients for the business application. Typically for each soft ware application to be shared, there is a group of recipients to which the initiating organization may send the software application to. The “group” may include only one recipient. At least one is required. Next is the partner company (organization) identification, which typically matches an existing company's information in the initiating organization's database. Next is the relevant email address of the partner organization, typically that of an administrator at the other organization. Next are the first and last names of the contact who is typically but not necessarily the same person as the administrator. Note that this invitation can first be routed internally for approval before sending to the other organization.

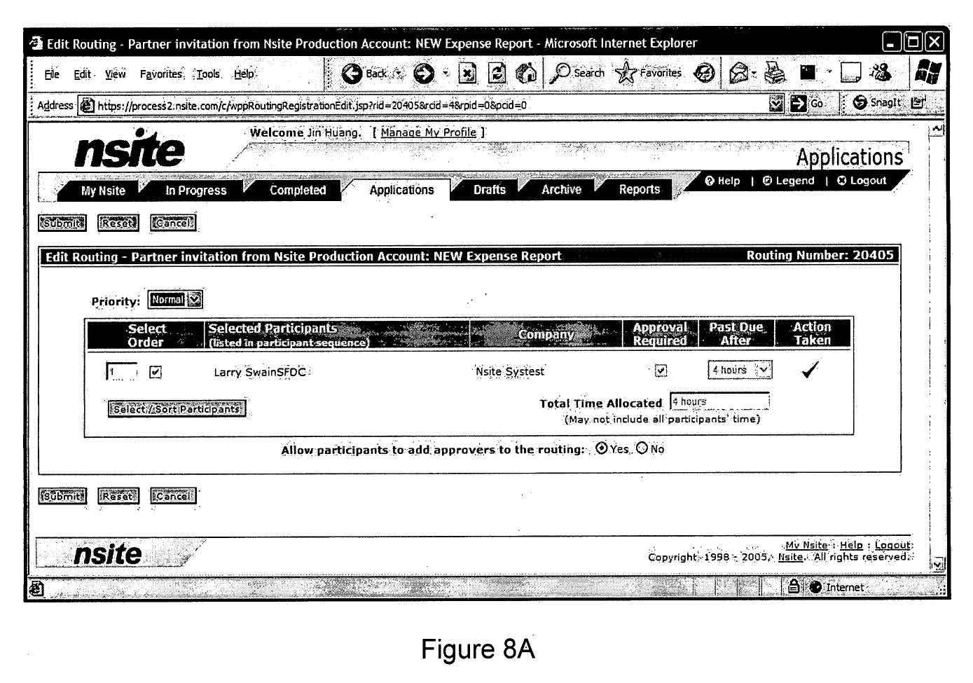

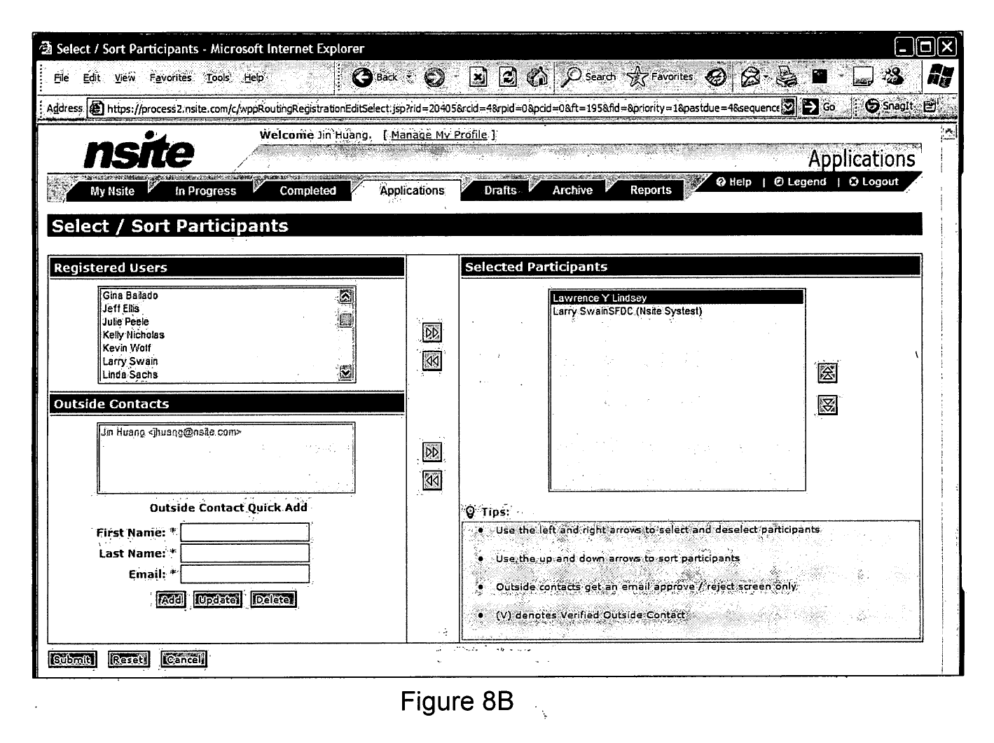

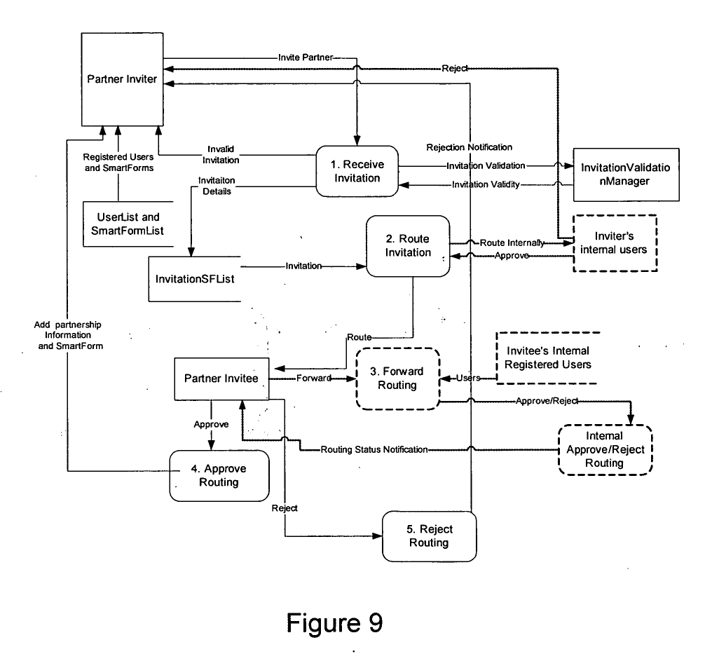

When a user submits the invitation after entering the required data, the user is then taken to a routing registration screen (page) also described below (FIG. 8A) where the user can select internal users to his organization. Typically, a last user on the initiator list is the administrator at the partner (invited) organization. At this point the select/sort participant screen of FIG. 8B is used. After the application has been internally approved it is routed to the administrator of the other organization for acceptance. Hence, FIG. 7 shows the invite partner screen and FIG. 8B shows the select/sort participants screen. FIG. 9 shows the overall system architecture and logic flow for this method.

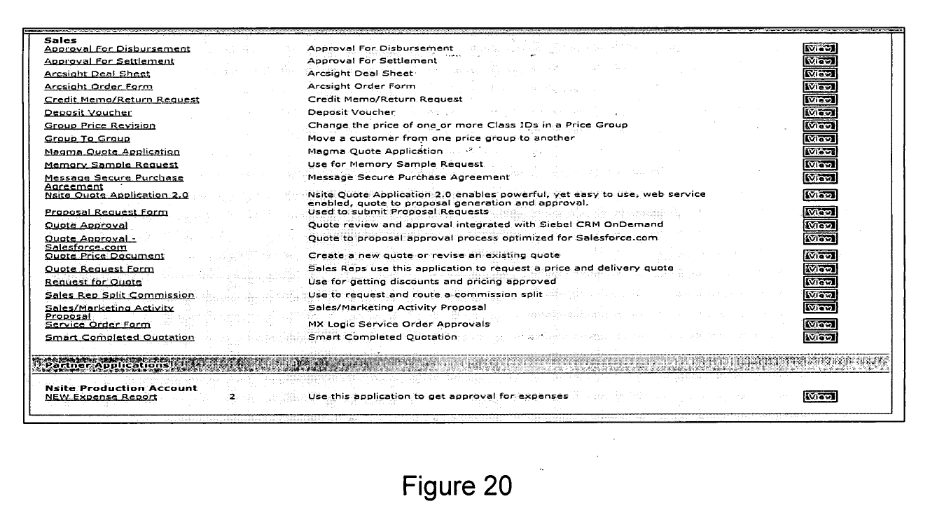

The routing can be of, e.g., one of three types-to several users in series in time, to a group of parallel users (all receiving at the same time), or by a queue, or a combination of these three types. Multiple recipients can be defined for the queue (ordered list) for the routing path. Typically whatever of the routing types is used, any one approver can veto acceptance. Hence approval of all is required for the application to be accepted. The queue is typically a standard FIFO (first in, first out) queue. The queues are part of the process control, see FIG. 20, as described below.

Next is the acceptance of the invitation by the invited organization. Typically the receiving administrator at the receiving (invited) organization will forward the software application in question to an approver or several approvers. Typically the administrator would be the last approver in the routing list. The approval of the invitation adds the partnership information and software application to the partner management page (screen) of both inviting and invited organizations. Next is the possibility of adding relevant users from both organizations in the partner management page. The invited organization administrator can add and/or remove initiators for the shared application(s), and the inviting organization administrator can add and/or remove approvers for the shared application(s).

It is also possible to post notes concerning any particular software application. The administrator for each organization decides whether participants from his organization can send notes to the other organization, that is to make the notes private (own organization only) or public (other organization also). One of the organizations may select public for notes while the other selects private.

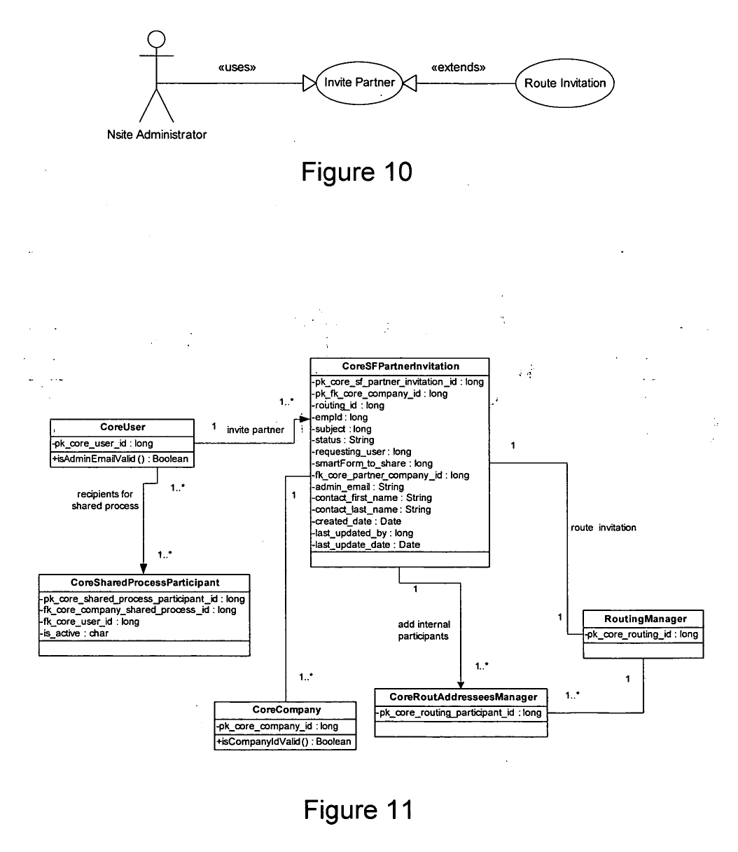

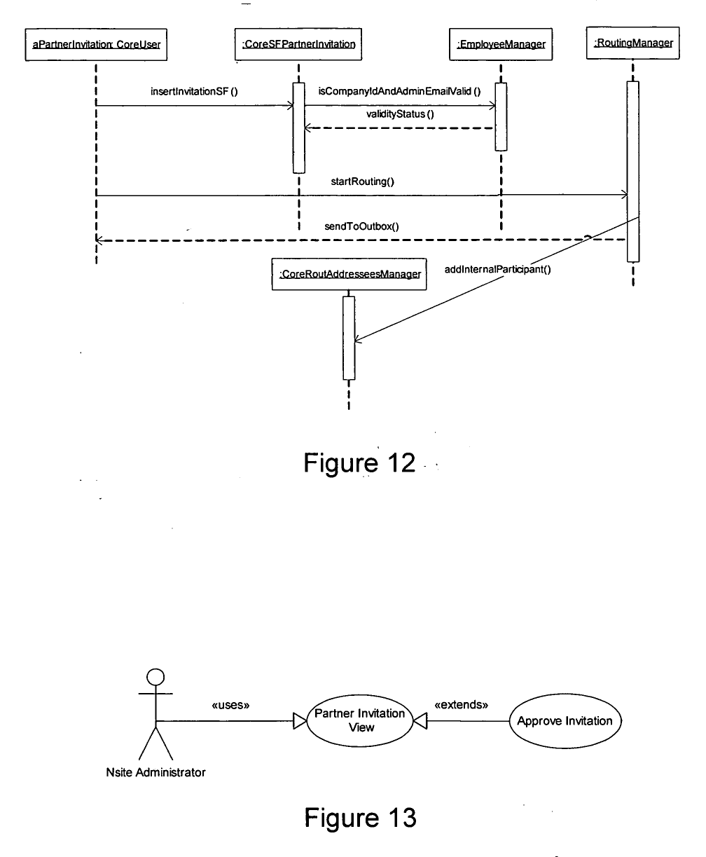

FIG. 10 shows diagrammatically the invitation process. As shown the invitation is transmitted from the administrator. FIG. 11 is the accompanying class diagram. As shown, each of these blocks is a software class identified as variously the user, the shared process participant, the partner invitation, the organization (company), the route addresses manager, and the routing manager. Each block then shows the attributes of each class. FIG. 12 shows the associated routing sequence.

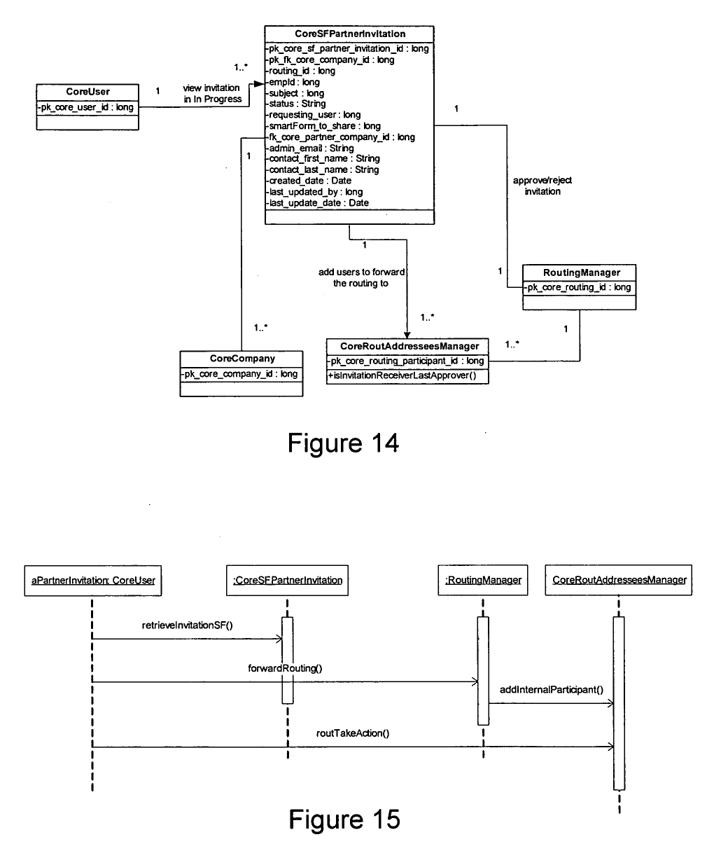

Next is the acceptance of the invitation shown diagrammatically in FIG. 13 where the administrator at the receiving (invited) organization transmits approval back. Associated with this (FIG. 14) is the class diagram in some respect similar to FIG. 11 but lacking the shared process participant block of FIG. 11. Each block of FIG. 14 shows the attributes of each class. FIG. 15 shows the associated routing sequence.

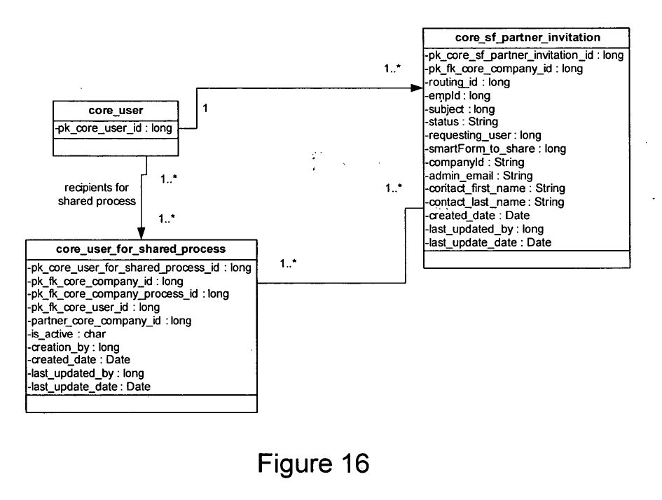

FIG. 16 is a class diagram illustrating portions of the invitation business application as referred to above. This includes as various classes the user, the user for the shared process, and the partner invitation, each with its associated data types.

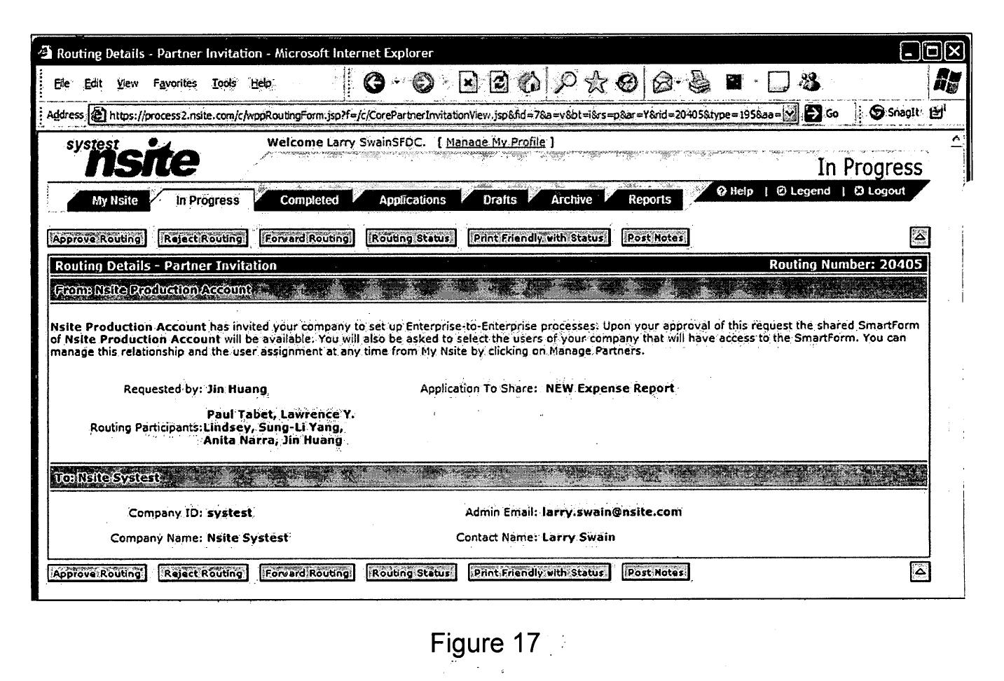

FIGS. 17-25 further illustrate by means of user screens operation of this system. In the present method first there is a connection between the two organizations which involves transmission of the invitation from the inviting organization to the recipient organization and an acceptance transmitted back. Next is the configuration phase in which the software application is activated and may be modified by one or the other organizations. Also included is the routing phase which employs lists of participants. Generally the system as described heretofore assumes there is an existing relationship between the two organizations achieved by means other than through the present system. However it is possible by a matchmaking or advertising aspect to eliminate the need for any prior relationship. Also note that the references to administrator here is merely illustrative; there is no need for a formal administrator, since various individuals may fill this role as needed in various embodiments.

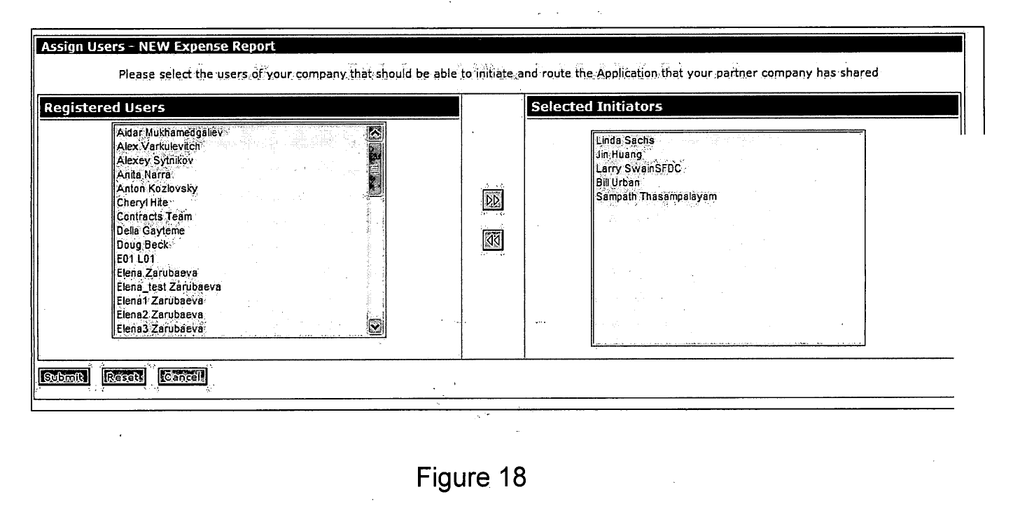

FIG. 17 shows a partner invitation screen for the administrator at the partner organization. FIG. 18 shows the following screen after the partner administrator approves the invitation. The partner administrator using the FIG. 18 screen can select initiators (assign users) for the shared software application called here “NEW Expense Report.”

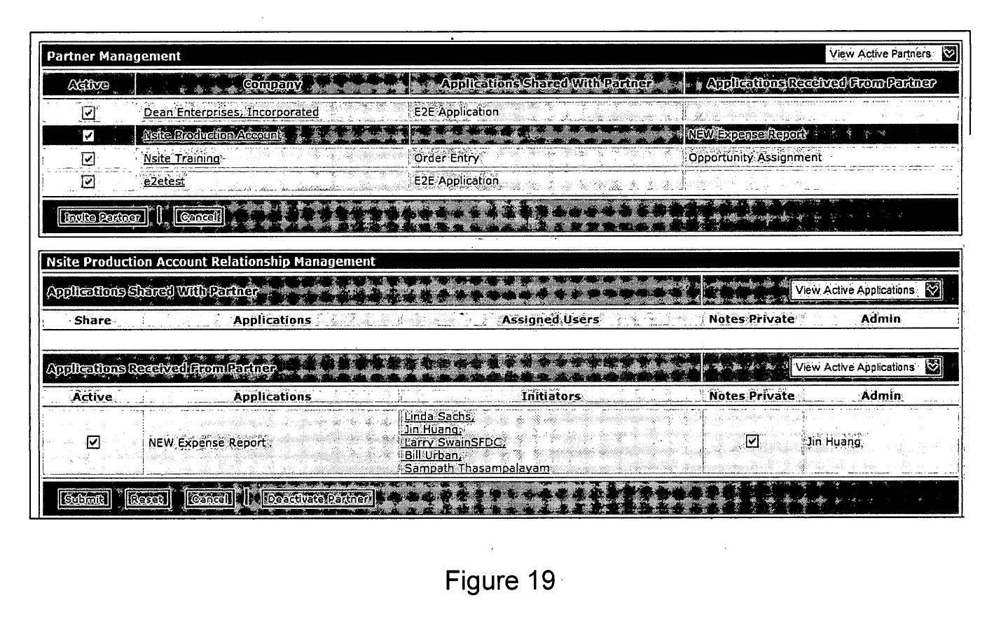

FIG. 19 shows the partner management screen mentioned above with a list of each of several organizations (upper left column) and the relevant shared software applications. In this case the software applications are characterized by their functionality which is a named business process which is here the “NEW Expense Report.” Upon clicking on the invite partner button in the upper portion of the screen, this invite partner block is activated and filled in with data as needed field by field by the user. When the receiving organization accepts an invitation it assigns an initiator in order to activate the software application.

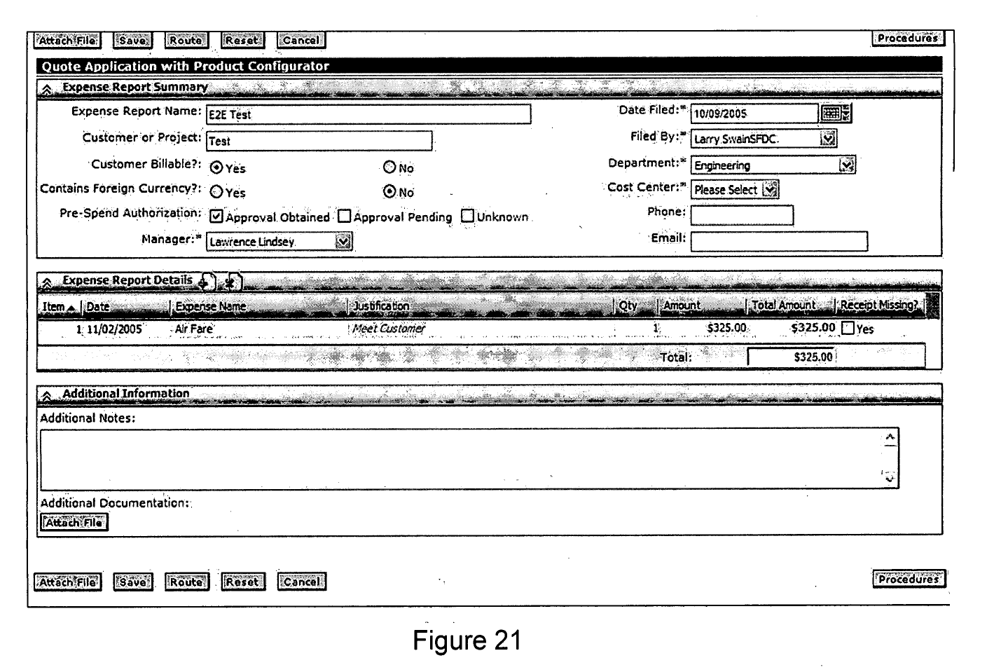

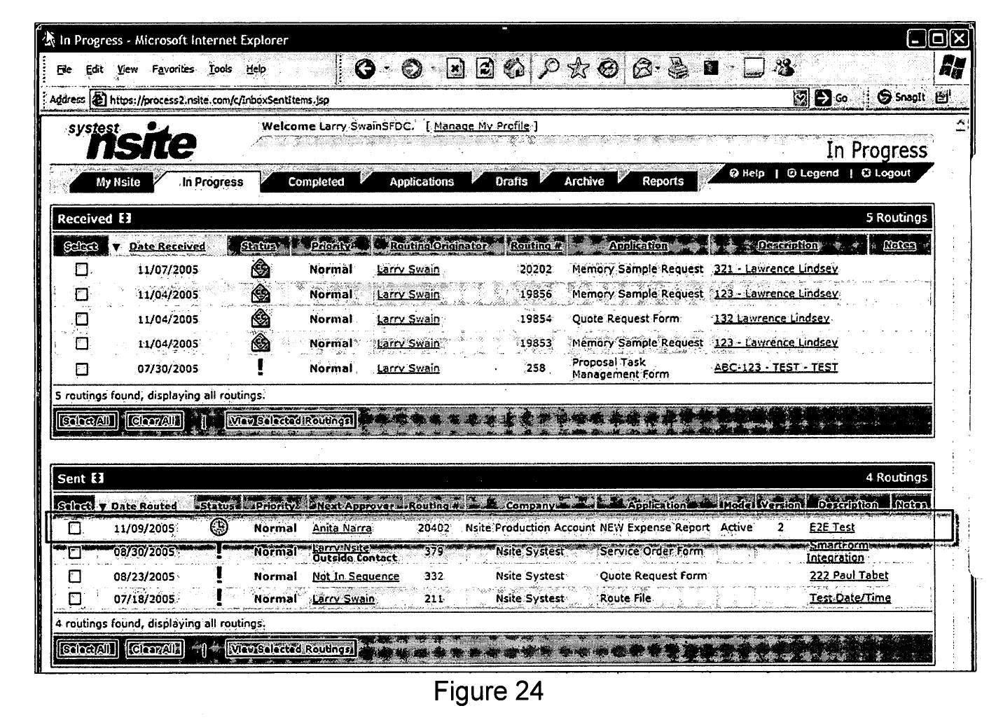

FIGS. 24-29 shows in sequence a complete sharing transaction. In the screen of FIG. 20 which shows a list of available applications, the partner user clicks on “NEW Expense Report” to select same. The partner user then fills out the relevant data for that software application and clicks on the “Route” button to send it to the selected approvers, in FIG. 21.

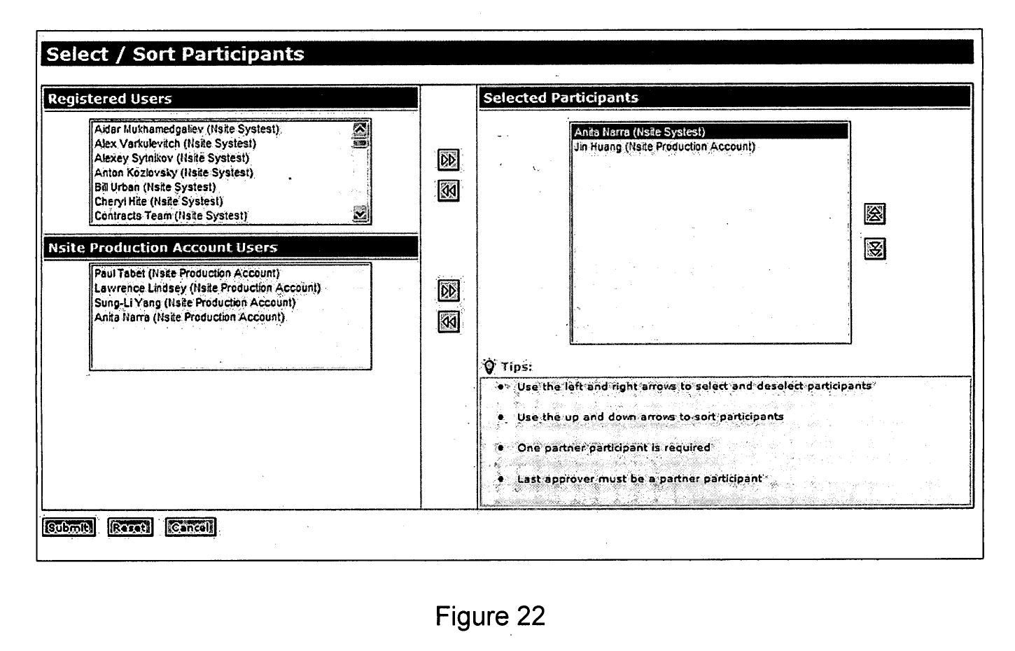

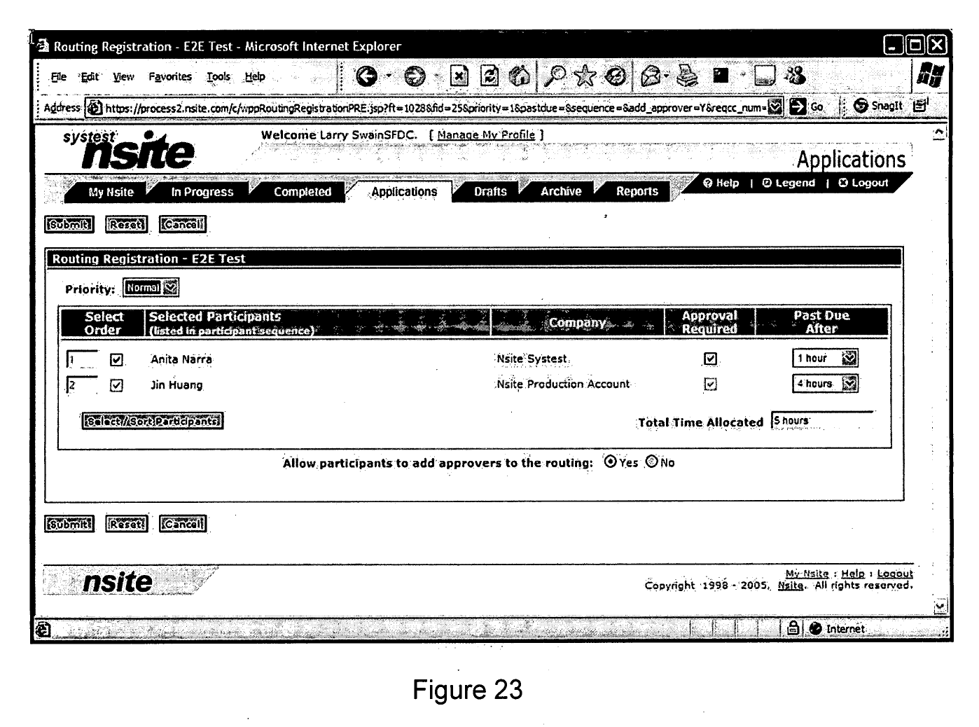

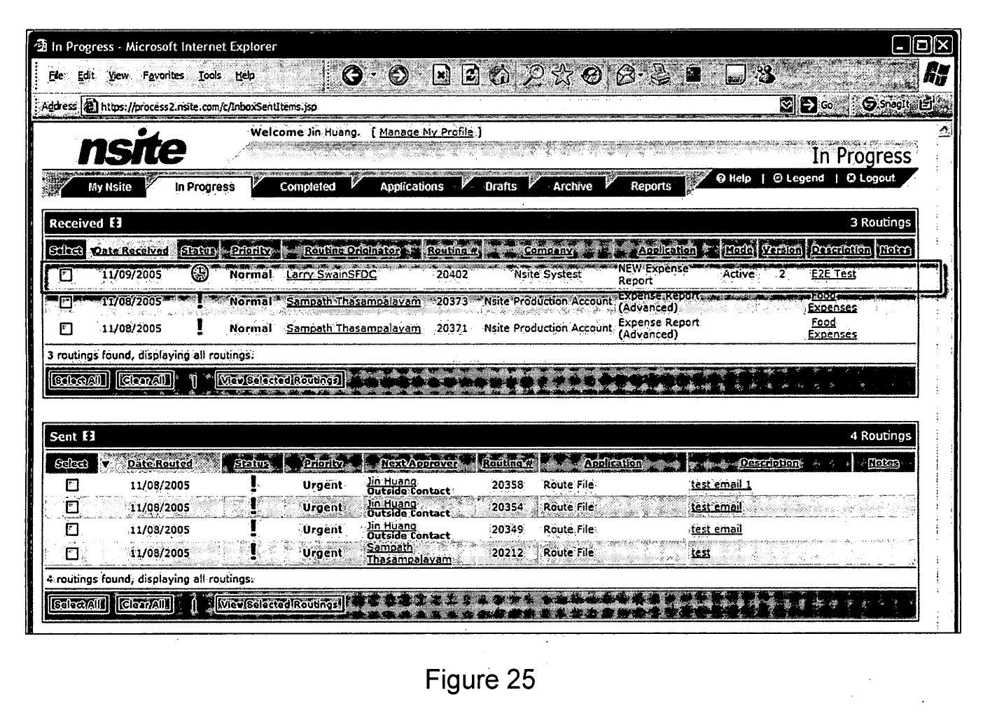

Next in the routing registration screen of FIG. 23, the user clicks on the “Select/Sort Participants” button. This brings up the Select/Sort Participants Screen of FIG. 22, where the user selects internal (own organization) and partner (other organization) approvers. After clicking on the “Submit” button (button of FIG. 22), the software application appears on the “In Progress” screen of FIG. 24. After the internal approver (“Anita Narra”)—see FIG. 23—approves, the software application is routed to the partner organization (“Nsite Production Account”) as shown in FIG. 25, the software application “NEW Expense Report” appears on the first approver's In Progress screen at the partner organization. That first approver can review the application in the application and approve it or forward it within his organization for further review or approval.

This disclosure is illustrative and not limiting; further modifications will be apparent to those skilled in the art in light of this disclosure and are intended to fall within the scope of the appended claims.

1. A computer enabled method for sharing a business process between two organizations, comprising the acts of:
providing a business process defined by a software application on a host platform, the software application being executable on a web browser;
transmitting over a computer network an invitation to share the business process from the first organization to the second organization, the invitation referring to the business process;
receiving over the computer network an acceptance of the invitation transmitted from the second to the first organization;
configuring the business process; and
routing access to the configured business process to recipients at at least one of the organizations.

2. The method of claim 1, wherein the configuring includes:
activating the business process; and
modifying the activated business process.

3. The method of claim 1, wherein the routing includes:
determining a list of recipients at each organization; and
sending a reference to the business process to each recipient.

4. The method of claim 1, wherein the software application includes at least one web page using data and logic.

5. The method of claim 1, wherein the activating is performed by the second organization.

6. The method of claim 1, further comprising the act of:
transmitting an invitation to share the application over a computer network to a third organization.

7. The method of claim 1, wherein a user at either organization performs the act of routing.

8. The method of claim 7, wherein a user at either organization routes the access to the application to recipients at the other organization.

9. The method of claim 1, wherein the invitation is transmitted to a particular recipient at the second organization.

10. The method of claim 1, further comprising the act of:
determining a list of recipients for the software application.

11. The method of claim 1, further comprising the act of:
transmitting the invitation and acceptance via the host platform.

12. The method of claim 1, wherein the recipients access the software application by a web browser.

13. The method of claim 1, further comprising the act of:
initiating from the second organization the configured business process.

14. A computer enabled method for sharing a business process between two organizations, comprising the acts of:
providing a business process defined by a software application on a host platform, the software application being executable on a web browser;
receiving over a computer network an invitation to share the business process sent from the first organization to the second organization, the invitation including a reference to the business process;
transmitting over the computer network an acceptance of the invitation from the second to the first organization;
configuring the business process; and
routing access to the configured business process to recipients at at least one of the organizations.

15. The method of claim 14, wherein the configuring includes:
activating the business process; and
modifying the activated business process.

16. The method of claim 14, wherein the routing includes:
determining a list of recipients at each organization; and
sending a reference to the business process to each recipient.

17. The method of claim 14, wherein the software application includes at least one web page using data and logic.

18. The method of claim 14, wherein the activating is performed by the second organization.

19. The method of claim 14, further comprising the act of:
transmitting an invitation to share the software application over a computer network to a third organization.

20. The method of claim 14, wherein a user at either organization performs the act of routing.

21. The method of claim 20, wherein a user at either organization routes the access to the application to recipients at the other organization.

22. The method of claim 14, wherein the invitation is received by a particular recipient at the second organization.

23. The method of claim 14, further comprising the act of:
determining a list of recipients for the software application.

24. The method of claim 14, further comprising the act of:
transmitting the invitation and acceptance via the host platform.

25. The method of claim 14, wherein the recipients access the software application by a web browser.

26. Computer enabled apparatus for sharing a business process between two organizations, comprising:
at least one business process defined as a software application being executable by a web browser;
a software application list which lists the at least one business process;
an invitation manager coupled to the software application list and which configures an invitation to share the business process from a first to a second organization, the invitation including the at least one software application;
a list of users of the software application; and
a routing manager coupled to the list of users and to the invitation manager and which transmits over a computer network the invitation to at least one selected recipient at the second organization.

27. The apparatus of claim 26, further comprising an invitation list having a plurality of invitations and coupled to the invitation manager.

28. The apparatus of claim 26, further comprising additional software applications, each listed in the software application list.

29. The apparatus of claim 26, further comprising:
a routing participants list; and
a routing addresses manager coupled to the routing participants list and to the routing manager and which provides email addresses of intended recipients of the invitation.

30. The apparatus of claim 26, wherein the software application includes at least one web page using data and logic.

31. The apparatus of claim 26, wherein the apparatus is a host platform.
